(19) United States
(12) Patent Application Publication
(10) Pub. No.: US 2026/0197480 A1
(43) Pub. Date: Jul. 9, 2026

(54) MESH DECODING DEVICE, MESH ENCODING DEVICE, MESH DECODING METHOD, AND NON-TRANSITORY COMPUTER-READABLE MEDIUM

(71) Applicant: KDDI CORPORATION, Tokyo (JP)

(72) Inventors: Jianfeng XU, Fujimino-shi (JP); Kyohei UNNO, Fujimino-shi (JP); Kei KAWAMURA, Fujimino-shi (JP)

(73) Assignee: KDDI CORPORATION, Tokyo (JP)

(21) Appl. No.: 19/553,030

(22) Filed: Feb. 27, 2026

Related U.S. Application Data
(63) Continuation of application No. PCT/JP2024/041299, filed on Nov. 21, 2024.

(30) Foreign Application Priority Data
Jan. 6, 2024 (JP) 2024-000911

(51) Int. Cl. H04N 19/44; G06T 9/00; H04N 19/169

(52) U.S. Cl. CPC H04N 19/44; G06T 9/001; H04N 19/188

(57) ABSTRACT

A mesh decoding device 200 receives bit streams of atlas, a base mesh, a displacement, and a texture encapsulated by a network abstraction layer (NAL) unit, wherein a TID defined as last 3 bits in a NAL header of the NAL unit is Temporal_ID plus 1, and LayerID/R6 defined as 6 bits immediately before the TID in the NAL head designates an identifier of a layer to which the NAL unit belongs.

### CROSS-REFERENCE TO RELATED APPLICATIONS

The present application is a continuation of PCT Application No. PCT/JP2024/041299, filed on Nov. 21, 2024, which claims the benefit of Japanese patent application No. 2024-000911 filed on Jan. 6, 2024, the entire contents of each application being incorporated herein by reference in its entirety.

### TECHNICAL FIELD

The present invention relates to a mesh decoding device, a mesh encoding device, a mesh decoding method, and a non-transitory computer-readable medium.

### BACKGROUND ART

Non Patent Literature 1 (Khaled Mammou, Jungsun Kim, Alexis M Tourapis, Dimitri Podborski, and Krasimir Kolarov, “[V-CG] Apple's Dynamic Mesh Coding CfP Response,” April 2022, ISO/IEC JTC 1/SC 29/WG 7 m59281) or Non Patent Literature 4 (“WD 5.0 of V-DMC,” October 2023, ISO/IEC JTC 1/SC 29/WG 7 N00744) discloses a technique for encoding a mesh by using Non Patent Literature 2 (Google Draco, accessed on May 26, 2022, [Online], https://google.github.io/draco) or 3 (Jean-Eudes Marvie, Olivier Mocquard, “[V-DMC][EE4.4-related] An efficient EdgeBreaker implementation,” April 2023, ISO/IEC JTC 1/SC 29/WG 7 m63344) according to the framework in Non Patent Literature 5 (“Information technology—Coded Representation of Immersive Media—Part 5: Visual Volumetric Video-based Coding (V3C) and Video-based Point Cloud Compression (V-PCC),” ISO/IEC JTC 1/SC 29/WG 7, ISO/IEC 23090-5:2021(2E)).

### SUMMARY OF THE INVENTION

However, in the related art, there is a problem that Temporal_scalability function can not be realized. Therefore, the present invention has been made in view of the above-described problems, and an object of the present invention is to provide a mesh decoding device, a mesh decoding method, and a non-transitory computer-readable medium capable of realizing Temporal_scalability function.

The first aspect of the present invention is summarized as a mesh decoding device: receives bit streams of atlas, a base mesh, a displacement, and a texture encapsulated by a network abstraction layer (NAL) unit, wherein a TID defined as last 3 bits in a NAL header of the NAL unit is Temporal_ID plus 1, and LayerID/R6 defined as 6 bits immediately before the TID in the NAL head designates an identifier of a layer to which the NAL unit belongs.

The second aspect of the present invention is summarized as a mesh decoding method including: a step of receiving bit streams of atlas, a base mesh, a displacement, and a texture encapsulated by a network abstraction layer (NAL) unit, wherein a TID defined as last 3 bits in a NAL header of the NAL unit is Temporal_ID plus 1, and LayerID/R6 defined as 6 bits immediately before the TID in the NAL head designates an identifier of a layer to which the NAL unit belongs.

The third aspect of the present invention is summarized as a non-transitory computer-readable medium having stored thereon a program for causing a computer to function as a mesh decoding device, the mesh decoding device receiving bit streams of atlas, a base mesh, a displacement, and a texture encapsulated by a network abstraction layer (NAL) unit, wherein a TID defined as last 3 bits in a NAL header of the NAL unit is Temporal_ID plus 1, and LayerID/R6 defined as 6 bits immediately before the TID in the NAL head designates an identifier of a layer to which the NAL unit belongs.

According to the present invention, it is possible to provide a mesh decoding device, a mesh decoding method, and a non-transitory computer-readable medium capable of realizing Temporal_scalability function.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3A is a diagram illustrating an example of a base mesh and a subdivided mesh.

FIG. 3B is a diagram illustrating an example of the base mesh and the subdivided mesh.

FIG. 4 is a diagram illustrating an example of functional blocks of a base mesh decoding unit 202 of the mesh decoding device 200 according to an embodiment.

FIG. 5 is a diagram illustrating an example of functional blocks of an intra decoding unit 202B of the base mesh decoding unit 202 of the mesh decoding device 200 according to an embodiment.

FIG. 6 is a diagram for describing an example of a correspondence between vertices of the base mesh of the P frame and vertices of the base mesh of the I frame.

FIG. 7 is a diagram illustrating an example of functional blocks of an inter decoding unit 202E of the base mesh decoding unit 202 of the mesh decoding device 200 according to an embodiment.

FIG. 8 is a diagram illustrating an example of a method for calculating the MVP of a vertex to be decoded by the motion vector prediction unit 202E3 of the inter-frame decoding unit 202E of the basic mesh decoding unit 202 of the mesh decoding device 200 according to an embodiment.

FIG. 9 is a flowchart illustrating an example of an operation of the motion vector prediction unit 202E3 of the inter-frame decoding unit 202E of the basic mesh decoding unit 202 of the mesh decoding device 200 according to an embodiment.

FIG. 10A is a diagram illustrating an example of a decoding order of a mesh.

FIG. 10B illustrates an example of a list of vertices around a vertex to be decoded.

FIG. 11 is a diagram illustrating an example of statistical data indicating a relationship between the number of decoded motion vectors and the number of vertices around a vertex to be decoded.

FIG. 12 is a diagram for describing an example of a worst case.

FIG. 13 is a diagram for describing the modification example 2 of the inter decoding unit 202E of the base mesh decoding unit 202 of the mesh decoding device 200 according to the embodiment.

FIG. 14 is a diagram for describing the modification example 2 of the inter decoding unit 202E of the base mesh decoding unit 202 of the mesh decoding device 200 according to the embodiment.

FIG. 15 is a diagram for describing the modification example 3 of the inter decoding unit 202E of the base mesh decoding unit 202 of the mesh decoding device 200 according to the embodiment.

FIG. 16 is a diagram illustrating a modification example of functional blocks of the modification example 1 of the base mesh decoding unit 202 of the mesh decoding device 200 according to an embodiment.

FIG. 17 is a diagram for describing the modification example 1 of the base mesh decoding unit 202 of the mesh decoding device 200 according to an embodiment.

FIG. 18 is a diagram for describing a mesh buffer unit 202C of the base mesh decoding unit 202 of the mesh decoding device 200 according to an embodiment.

FIG. 19 is a diagram for describing a mesh buffer unit 202C of the base mesh decoding unit 202 of the mesh decoding device 200 according to an embodiment.

FIG. 20 is a diagram for describing the modification example of the base mesh decoding unit 202 of the mesh decoding device 200 according to an embodiment.

FIG. 21 is a diagram for describing the modification example of the base mesh decoding unit 202 of the mesh decoding device 200 according to an embodiment.

FIG. 22 is a diagram illustrating an example of a NAL header.

FIG. 23 is a diagram illustrating an example of a case where the number of submeshes varies in each frame.

FIG. 24 is a diagram illustrating an example of a case where corresponding submeshes have different SubmeshID between frames.

### DETAILED DESCRIPTION

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

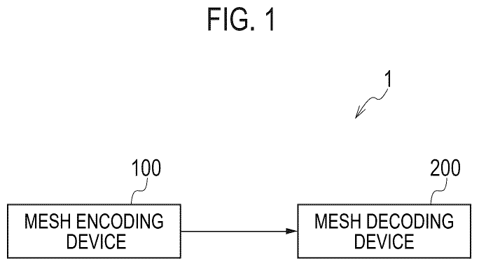

Hereinafter, a mesh processing system according to the present embodiment will be described with reference to FIGS. 1 to 24.

FIG. 1 is a diagram illustrating an example of a configuration of a mesh processing system 1 according to the present embodiment. As illustrated in FIG. 1, the mesh processing system 1 includes a mesh encoding device 100 and a mesh decoding device 200.

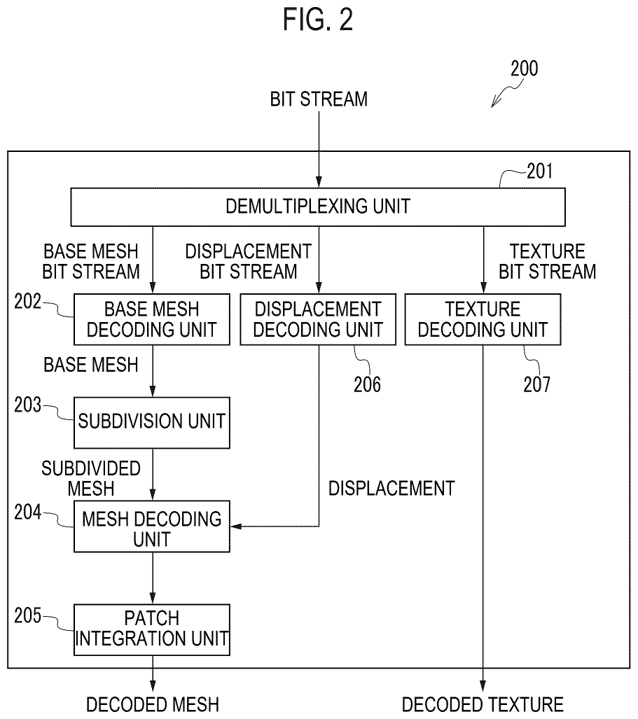

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a patch integration unit 205, a displacement decoding unit 206, a video decoding unit 207, and an atlas data decoding unit 208.

Here, the base mesh decoding unit 202, the subdivision unit 203, the mesh decoding unit 204, and the displacement decoding unit 206 may be configured to perform processing in units of patches obtained by dividing a mesh, and the patch integration unit 205 may be configured to integrate the processing results thereafter.

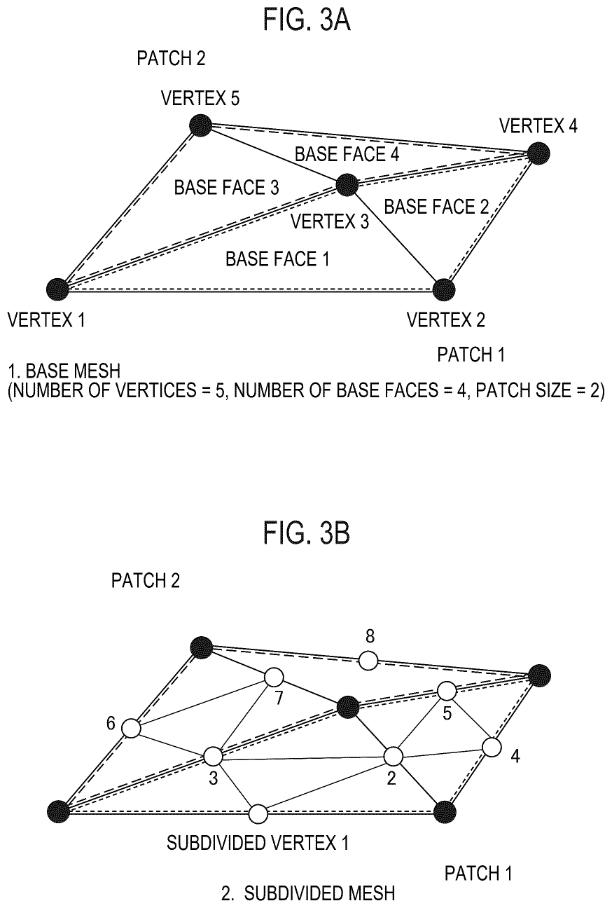

In the example of FIG. 3A, the mesh is divided into a patch 1 having base faces 1 and 2 and a patch 2 having base faces 3 and 4.

The demultiplexing unit 201 is configured to separate a multiplexed bit stream into a base mesh bit stream, a displacement bit stream, a texture bit stream, and an atlas bit stream.

The atlas data decoding unit 208 is configured to decode an atlas bit stream and output control information. The control signal may be used as metadata in the base mesh decoding unit 202, the subdivision unit 203, the mesh decoding unit 204, the displacement decoding unit 206, and the video decoding unit 207.

### <Base Mesh Decoding Unit 202>

The base mesh decoding unit 202 is configured to decode the base mesh bit stream, and generate and output a base mesh.

Here, the base mesh includes a plurality of vertices in a three-dimensional space and edges connecting the plurality of vertices.

As illustrated in FIG. 3A, the base mesh is configured by combining base faces expressed by three vertices.

The base mesh decoding unit 202 may be configured to decode the base mesh bit stream using, for example, Draco described in Non Patent Literature 2 or the technology described in Non Patent Literature 3.

Furthermore, the base mesh decoding unit 202 may be configured to generate “subdivision_method_id” described below as control information for controlling a type of a subdivision method.

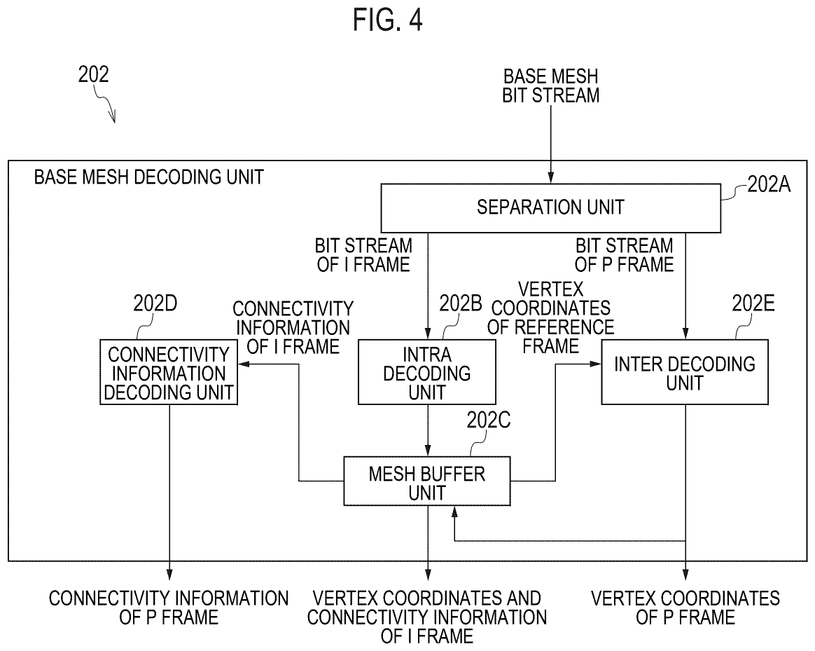

As illustrated in FIG. 4, the base mesh decoding unit 202 includes a separation unit 202A, an intra decoding unit 202B, a mesh buffer unit 202C, a connectivity information decoding unit 202D, and an inter decoding unit 202E.

The separation unit 202A is configured to classify the base mesh bit stream into an I-frame bit stream and a P-frame bit stream.

### (Intra Decoding Unit 202B)

The intra decoding unit 202B is configured to decode coordinates and connectivity information of vertices of an I frame from the I-frame bit stream using, for example, Draco described in Non Patent Literature 2 or the technology described in Non Patent Literature 3.

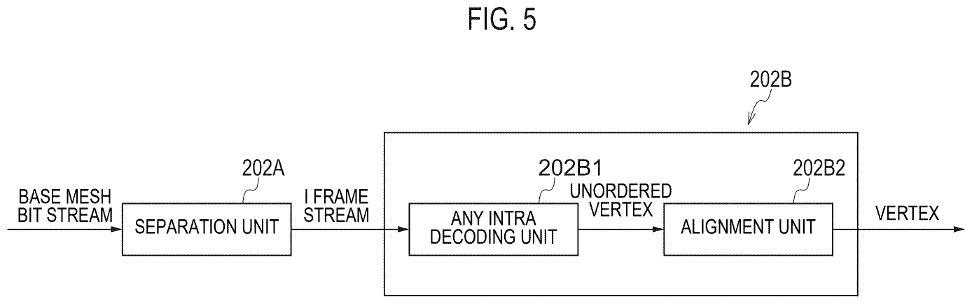

FIG. 5 is a diagram illustrating an example of functional blocks of the intra decoding unit 202B.

As illustrated in FIG. 5, the intra decoding unit 202B includes an any intra decoding unit 202B1 and an alignment unit 202B2.

The any intra decoding unit 202B1 is configured to decode the coordinates and the connectivity information of the unordered vertex of the I frame from the bit stream of the I frame using any method including Draco described in Non Patent Literature 2 or the technology described in Non Patent Literature 3.

The alignment unit 202B2 is configured to output the vertices by rearranging the unordered vertices in a predetermined order.

As the predetermined order, for example, a Morton code order may be used, or a raster scan order may be used.

Furthermore, the alignment unit 202B2 may collectively set duplicate vertices that are a plurality of vertices having identical coordinates in the decoded base mesh as a single vertex, and then rearranges the vertices in a predetermined order.

The mesh buffer unit 202C is configured to accumulate coordinates and connectivity information of vertices of the I frame decoded by the intra decoding unit 202B. Here, a specific buffer that stores a pair of indexes A(k) and B(k) of vertices existing as duplicate vertices in a predetermined order may be provided.

The connectivity information decoding unit 202D is configured to set the connectivity information of the I frame extracted from mesh buffer unit 202C as the connectivity information of the P frame.

The inter decoding unit 202E is configured to decode the coordinates of the vertices of the P frame by adding the coordinates of the vertices of the I frame extracted from the mesh buffer unit 202C and the motion vector decoded from the bit stream of the P frame.

Furthermore, the inter decoding unit 202E can adjust the index of the vertex of the P frame by the pair of indices A(k) and B(k) of the vertices existing as the duplicate vertices stored in the specific buffer.

Here, all or some of the indexes described above are decoded from the bit stream. Such a decoding method may be arithmetic encoding. As a result, an effect that the maximum value of the index to be decoded using the arithmetic encoding is not limited can be expected.

For example, the arithmetic encoding of ue(v) may be used. ue(v) indicates exponential-Golomb encoding (Exp-Golomb) of an unsigned integer 0-order with a first left bit.

Specifically, the interpretation process of the syntax element of ue(v) starts from the current position in the bit stream, and starts by reading bits including the first non-zero bit and counting the number of preceding bits equal to 0. The process is designated as follows:

$$leadingZeroBits = - 1$$

$$for ( b = 0 ; ! b ; leadingZeroBits ++$$

$$b = read\_bits ( l )$$

The variable codeNum is then assigned as follows:

$$codeNum = 2 leadingZeroBits - 1 + read\_bits ( leadingZeroBits )$$

However, the value returned by read bits (leadingZeroBits) is interpreted as a binary representation of the unsigned integer the most significant bit of which was previously written. Also, the value of ue(v) is equal to the value of codeNum.

Table 1 illustrates the structure of the Exp-Golomb code, separating the bit string into a “prefix” bit and a “suffix” bit.

TABLE 1

| BIT STRING | CodeNum RANGE |
|---|---|
| 1 | 0 |
| 01x₀ | 1 . . . 2 |
| 001x₁x₀ | 3 . . . 6 |
| 0001x₂x₁x₀ | 7 . . . 14 |
| 00001x₃x₂x₁x₀ | 15 . . . 30 |
| 000001x₄x₃x₂x₁x₀ | 31 . . . 62 |
| . . . | . . . |

Here, the “prefix” bit is a bit that is interpreted as being designated in the calculation of leadingZeroBits, and is indicated as 0 or 1 in the bit string in Table 1.

The “suffix” bit is a bit interpreted in the calculation of codeNum and is indicated as xi in Table 1. i ranges from 0 to leadingZeroBits−1. Each xi is equal to either 0 or 1.

Table 2 illustrates how to explicitly assign a bit string to the value of codeNum. Here, the value of ue(v) is equal to the value of codeNum.

TABLE 2

| BIT STRING | codeNum |
|---|---|
| 1 | 0 |
| 010 | 1 |
| 011 | 2 |
| 00100 | 3 |
| 00101 | 4 |
| 00110 | 5 |
| 00111 | 6 |
| 0001000 | 7 |
| 0001001 | 8 |
| 0001010 | 9 |
| . . . | . . . |

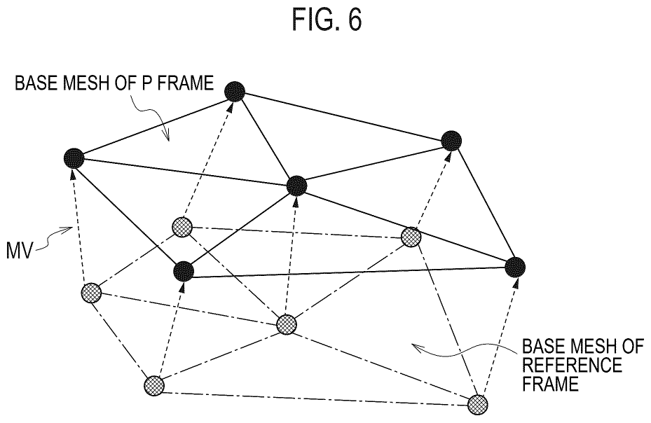

In the present embodiment, as illustrated in FIG. 6, there is a correspondence between the vertices of the base mesh of the P frame and the vertices of the base mesh of the reference frame (I frame or P frame). Here, the motion vector decoded by the inter decoding unit 202E is a difference vector between the coordinates of the vertex of the base mesh of the P frame and the coordinates of the vertex of the base mesh of the I frame.

The inter decoding unit 202E may decode the number of vertices of the current frame or the current submesh from the bit stream.

Here, in a case where the inter decoding unit 202E decodes the number of vertices of the current frame or the current submesh from the above-described bit stream, the conformity requirement of such bit stream is that the number of vertices of the decoded current frame or the current submesh needs to be equal to the number of vertices of a reference frame or a reference submesh.

When decoding the number of vertices of the current frame or the current submesh from the bit stream, the inter decoding unit 202E is configured to preferentially use the number of vertices of the current frame or the current submesh decoded from the bit stream when the number of vertices of the decoded current frame or current submesh is different from the number of vertices of the reference frame or the reference submesh.

Furthermore, the inter decoding unit 202E may directly use the number of vertices of the reference frame or the reference submesh as the number of vertices of the current frame or the current submesh.

In such a case, in a case where the number of vertices of the current frame or the current submesh is larger than the number of vertices of the reference frame or the reference submesh, the inter decoding unit 202E may add a dummy vertex and connectivity information of the dummy vertex to the reference frame or the reference submesh.

Here, the inter decoding unit 202E may set coordinates of the dummy vertex to fixed values (for example, (0,0,0)), or may copy the dummy vertex from a predetermined vertex (for example, the last vertex of the reference frame).

Furthermore, the inter decoding unit 202E may copy a necessary portion from the beginning of connectivity information of the vertex in the reference frame or the reference submesh as the connectivity information of the dummy vertex.

According to such a configuration, an effect of guaranteeing an operation of decoding the current frame or the current submesh can be expected.

Since the base mesh has at least one face and the face has at least three or more vertices, a control signal indicating the number of vertices for each frame or each submesh is limited to include three or more vertices.

For example, the control signal pdu_vertex_count_minus_1[titleID][patchIdx] defined in clause 8.3.7.3 of [Non Reference Literature 4], the control signal sismu_inter_vertex_count[subMeshID] defined in clause H. 8.1.3.8, and the control signal mesh_vertex_count defined in clause 1.8.3.7 are changed as shown in Table 3 and limited to include three or more vertices.

Here, the control signal pdu_vertex_count_minus_1[titleID][patchIdx] is a control signal that designates the number of vertices in a patch having patchID equal to patchID (patch ID) specified by [patchIdx] in an atlas tile having tileID equal to tileID (tile ID) specified by [titleID].

The control signal sismu_inter_vertex_count [subMeshID] is a control signal that designates the number of vertices in a submesh having SubmeshID equal to SubmeshID designated by [subMeshID].

The control signal mesh_vertex_count is a control signal that designates the number of vertices in the decoded mesh.

TABLE 3

| BEFORE CHANGE | AFTER CHANGE |
|---|---|
| pdu_vertex_count_minus1[tileID][patchIdx] | pdu_vertex_count_minus3[tileID][patchIdx] |
| sismu_inter_vertex_count[subMeshID] | sismu_inter_vertex_count_minus3[subMeshID] |
| mesh_vertex_count | mesh_vertex_count_minus3 |

According to such a configuration, it is possible to expect an effect that a situation in which a vertex operates with meaningless data such as 1 or 2 can be prevented.

### (Inter Decoding Unit 202E)

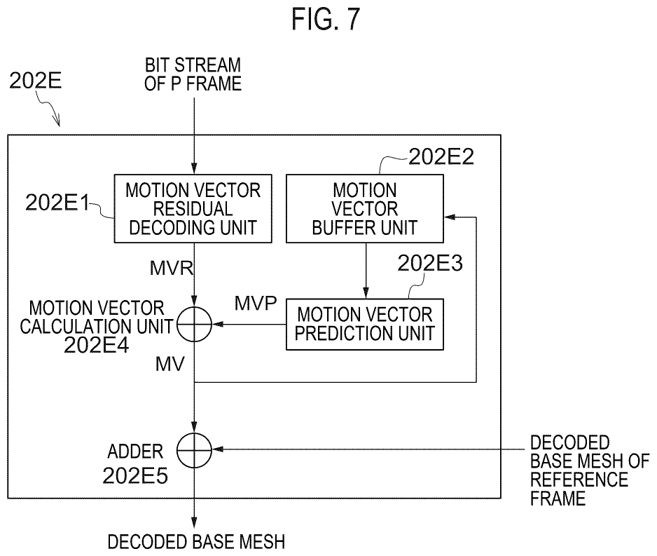

FIG. 7 is a diagram illustrating an example of functional blocks of the inter decoding unit 202E.

As illustrated in FIG. 7, the inter decoding unit 202E includes a motion vector residual decoding unit 202E1, a motion vector buffer unit 202E2, a motion vector prediction unit 202E3, a motion vector calculation unit 202E4, and an adder 202E5.

The motion vector residual decoding unit 202E1 is configured to generate a motion vector residual (MVR) from a P frame bit stream.

Here, the MVR is a motion vector residual indicating a difference between a motion vector (MV) and a motion vector prediction (MVP). The MV is a difference vector (motion vector) between the coordinates of the vertex of the corresponding I frame and the coordinates of the vertex of the P frame. The MVP is a predicted value of the MV of a target vertex using the MV (a predicted value of a motion vector).

The motion vector buffer unit 202E2 is configured to sequentially store the MVs output by the motion vector calculation unit 202E4.

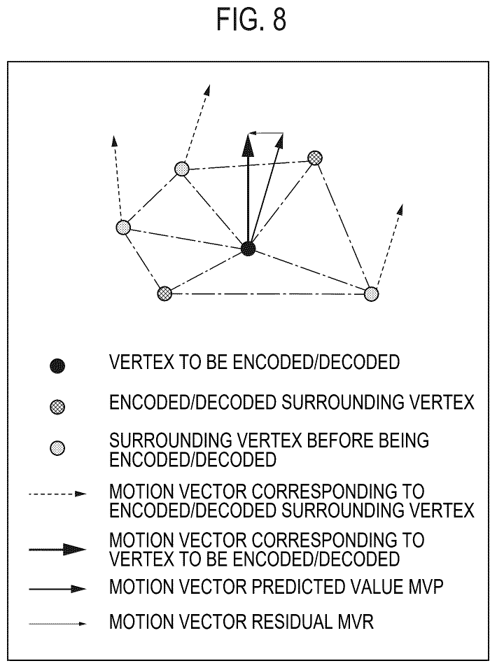

The motion vector prediction unit 202E3 is configured to acquire the decoded MV from the motion vector buffer unit 202E2 for the vertex connected to the vertex to be decoded, and output the MVP of the vertex to be decoded using all or some of the acquired decoded MVs as illustrated in FIG. 8.

The motion vector calculation unit 202E4 is configured to add the MVR generated by the motion vector residual decoding unit 202E1 and the MVP output from the motion vector prediction unit 202E3, and output the MV of the vertex to be decoded.

The adder 202E5 is configured to add the coordinates of the vertex corresponding to the vertex to be decoded obtained from the decoded base mesh of the reference frame (I frame or P frame) having the correspondence and the motion vector MV output from the motion vector calculation unit 202E3, and output the coordinates of the vertex to be decoded.

Details of each unit of the inter decoding unit 202E will be described below.

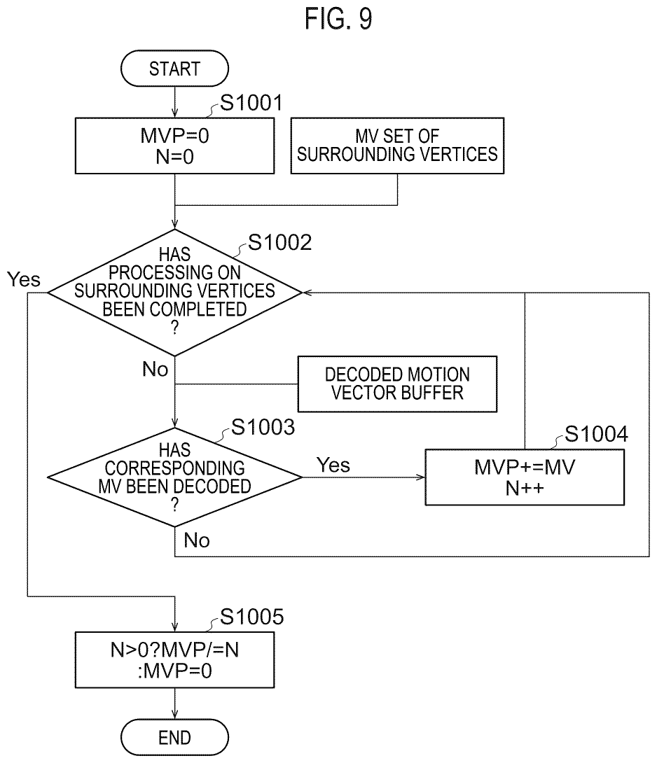

FIG. 9 is a flowchart illustrating an example of the operation of the motion vector prediction unit 202E3. Hereinafter, the operation of the motion vector prediction unit 202E3 will be referred to as an “average prediction method”.

As illustrated in FIG. 9, in step S1001, the motion vector prediction unit 202E3 sets the MVP and N to 0.

In step S1002, the motion vector prediction unit 202E3 acquires a set of MVs of vertices around the vertex to be decoded from the motion vector buffer unit 202E2, identifies a vertex for which subsequent processing has not been completed, and transitions to No. In a case where the subsequent processing has been completed for all vertices, the motion vector prediction unit 202E3 transitions to Yes.

In step S1003, the motion vector prediction unit 202E3 transitions to No when the MV of the vertex to be processed has not been decoded, and transitions to Yes if the MV of the vertex to be processed has been decoded.

In step S1004, the motion vector prediction unit 202E3 adds the MV to the MVP and adds 1 to N.

In step S1005, the motion vector prediction unit 202E3 outputs a result obtained by dividing the MVP by N when N is larger than 0, outputs 0 when N is 0, and ends the process.

That is, the motion vector prediction unit 202E3 is configured to output the MVP to be decoded by averaging the decoded motion vectors of the vertices around the vertex to be decoded.

Note that the motion vector prediction unit 202E3 may be configured to set the MVP to 0 in a case where the set of decoded motion vectors is an empty set.

The motion vector calculation unit 202E4 may be configured to calculate the MV of the vertex to be decoded from the MVP output by the motion vector prediction unit 202E3 and the MVR generated by the motion vector residual decoding unit 202E1 according to Expression (1).

$$M V ( k ) = M V P ( k ) + M V R ( k ) \qquad ( 1 )$$

Here, k is an index of a vertex. MV, MVR, and MVP are vectors having an x component, a y component, and a z component.

According to such a configuration, since only the MVR is encoded instead of the MV using the MVP, it is possible to expect an effect of increasing the encoding efficiency.

The adder 202E5 is configured to calculate the coordinates of the vertex by adding the MV of the vertex calculated by the motion vector calculation unit 202E4 and the coordinates of the vertex of the reference frame corresponding to the vertex, and keep the connectivity information (Connectivity) as a reference frame.

Specifically, the adder 202E5 may be configured to calculate the coordinate v′i(k) of the k-th vertex using Expression (2).

$${v}^{′} i ( k ) = {v}^{′} j ( k ) + MV ( k ) \qquad ( 2 )$$

Here, v′i(k) is a coordinate of a k-th vertex to be decoded in the frame to be decoded, v′j(k) is a coordinate of a decoded k-th vertex of the reference frame, MV(k) is a k-th MV of the frame to be decoded, and k=1, 2, . . . , K.

Further, the connectivity information of the frame to be decoded is made a same as the connectivity information of the reference frame.

Note that, since the motion vector prediction unit 202E3 calculates the MVP using the decoded MV, the decoding order affects the MVP.

The decoding order is the decoding order of the vertices of the base mesh of the reference frame. In general, in the case of a decoding method in which the number of base faces is increased one by one from an edge serving as a starting point using a constant repetition pattern, the order of vertices of the decoded base mesh is determined in the process of decoding.

For example, the motion vector prediction unit 202E3 may determine the decoding order of the vertices using Edgebreaker in the base mesh of the reference frame.

According to such a configuration, since the MV from the reference frame is encoded instead of the coordinates of the vertex, it is possible to expect an effect of increasing the encoding efficiency.

### Modification Example 1 of Inter Decoding Unit 202E

Hereinafter, Modification Example 1 of the inter decoding unit 202E will be described.

In the “average prediction method” of averaging decoded motion vectors of vertices around a vertex to be decoded, the motion vector prediction unit 202E3 of the inter decoding unit 202E calculates the MVP using all or only some of the decoded motion vectors of the vertices around the vertex to be decoded so as not to exceed a maximum usage number determined in advance.

Note that the maximum usage number determined in advance is decoded from the bit stream as a control signal.

Furthermore, in a case where the number of decoded motion vectors of vertices around the vertex to be decoded exceeds the maximum usage number, the motion vector prediction unit 202E3 picks up motion vectors up to the maximum usage number according to a certain rule.

For example, the motion vector prediction unit 202E3 selects the first or last vertex in the decoding order as such a rule.

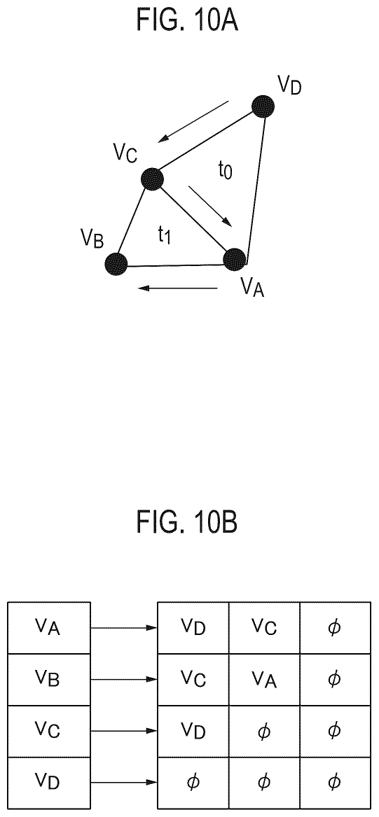

The decoding order for the mesh as illustrated in FIG. 10A is vertices vD→vC→vA→vB as indicated by arrows.

FIG. 10B is a list of vertices around the vertex to be decoded used when the MVP of each of the vertices vA to vD is calculated when the maximum value of the number of decoded neighboring vertices is set to 3.

According to such a configuration, by determining the maximum number of neighboring vertices, an effect of reducing the calculation amount and the memory amount while maintaining or slightly reducing the encoding efficiency can be expected.

However, in order to exhibit the above-described effect, it is necessary to set an appropriate maximum number of neighboring vertices in the mesh encoding device 100 and write the maximum number of neighboring vertices in the bit stream as an associated control signal.

Therefore, since the memory amount prepared by the mesh decoding device 200 is determined in the range that can be set as the maximum number of neighboring vertices described above, encoding/decoding is performed so that the maximum number of neighboring vertices becomes equal to or less than a preset maximum value as a reasonable constraint regarding the maximum number of neighboring vertices.

As described above, by defining a reasonable constraint regarding the maximum number of neighboring vertices, an effect of facilitating the design of the mesh decoding device 200 can be expected.

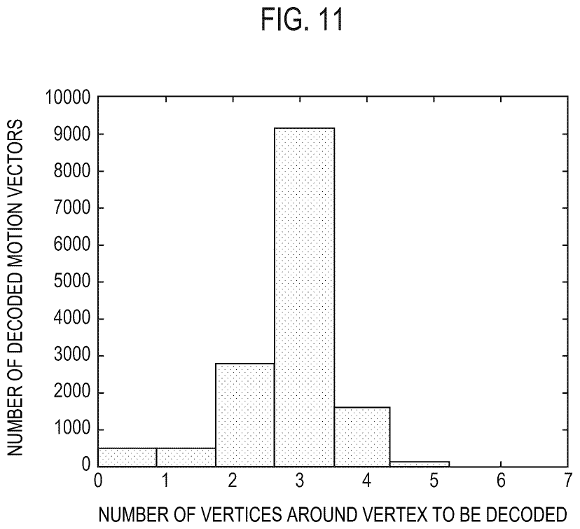

In general, the average of the number of neighboring vertices in the Closed 2-manifold triangle mesh is about six, but statistically, the maximum number of neighboring vertices is often seven to eight. As illustrated in FIG. 11, the number of decoded motion vectors (vertical axis) dynamically changes according to the number of vertices around the vertex to be decoded (horizontal axis).

Therefore, it is desirable to narrow the range that can be set as the maximum number of neighboring vertices described above.

For example, as illustrated in FIG. 11, the effect of reducing the calculation amount and the memory amount can be exerted by including “three”, which is the number of vertices around the vertex to be decoded having the largest number of decoded motion vectors statistically, within the range that can be set as the maximum number of neighboring vertices in the control signal described above, or by setting a value that is not larger than a natural number that can be covered up to a certain ratio (for example, 50% or 120%) or N bits (for example, 3 bits) of the average of the statistical number of neighboring vertices to the upper limit (maximum value) of the range that can be set as the maximum number of neighboring vertices in the control signal described above.

On the other hand, if the range that can be set as the maximum number of neighboring vertices is set to a large value, for example, 256 or 8 bits in the worst case, there is a possibility that the effect of reducing not only the memory amount but also the calculation amount cannot be exhibited.

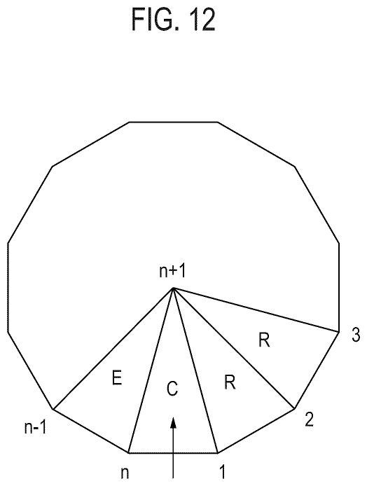

FIG. 12 illustrates an example of a worst case, and when n≥256, the number of decoded neighboring vertices exceeds 256. In FIG. 12, the number of decoded neighboring vertices at the vertex n+1 is n.

In a case where the upper limit of the maximum number of neighboring vertices is set to 256, the mesh decoding device 200 requires not only a large memory but also a large calculation amount as illustrated in FIG. 10B. Therefore, the upper limit (maximum value) of the range that can be set as the maximum number of neighboring vertices described above may be 8.

The range that can be set as the maximum number of neighboring vertices in the above-described control signal may be a clear value, or may be calculated from other control signals or data.

For example, a range that can be set as the maximum number of neighboring vertices in the control signal may be defined by Levell.

Alternatively, the upper limit of the range that can be set as the maximum number of neighboring vertices in the control signal may be calculated from the number of vertices of the base mesh according to the following Expression (3).

Upper limit of range that can be set as maximum number of neighboring vertices in control signal=log 2(number of vertices of base mesh) Expression (3)

According to such a configuration, a settable range of the maximum number of neighboring vertices can be appropriately determined, and an effect of reliably reducing both the calculation amount and the memory amount can be expected even in the worst case.

The inter decoding unit 202E decodes coordinates of the decoding target vertex by adding the MV decoded from the bit stream of the inter frame and the coordinates of the vertex corresponding to the decoding target vertex in the reference frame.

Further, the motion vector prediction unit 202E3 calculates a predicted value of the motion vector of the decoding target vertex by averaging all or some of the motion vectors of the decoded vertices adjacent to the decoding target vertex with reference to the adjacent vertex list. Here, the adjacent vertex list is a list of vertices adjacent to each vertex.

The motion vector prediction unit 202E3 may reuse the adjacent vertex list in the reference frame as the adjacent vertex list in the current frame. Here, it is assumed that the adjacent vertex list includes decoded vertices picked up to the maximum usage number (set maximum adjacent vertex number).

Here, the motion vector prediction unit 202E3 can reuse the adjacent vertex list in the reference frame in a case where a condition (reuse condition) that each vertex in the reference frame and each vertex in the current frame have a one-to-one correspondence, the decoding order of each vertex in the reference frame and the decoding order of each vertex in the current frame are the same, and the adjacent vertex list including the decoded vertices picked up to the maximum usage number in the reference frame has already been stored is satisfied.

For example, in a case where the reference frame is a P frame or an S frame when the reference frame is decoded, there is an adjacent vertex list including the decoded vertices picked up to the maximum usage number.

Therefore, when the reference frame is decoded and the reference frame is a P frame or an S frame, the motion vector prediction unit 292E3 stores the decoded reference frame in a reference frame buffer, and stores the adjacent vertex list in the reference frame in a specific buffer.

In a case where the type of the reference frame is the P frame or the S frame when the current frame is decoded, the motion vector prediction unit 292E3 reuses the adjacent vertex list in the reference frame stored in the specific buffer as the adjacent vertex list in the current frame.

However, there is a possibility that the adjacent vertex list including the decoded vertices picked up to the maximum usage number in one or a plurality of frames is stored in the specific buffer.

Therefore, in a case where the adjacent vertex list in a plurality of frames is stored in the specific buffer, the motion vector prediction unit 202E3 reuses the adjacent vertex list in the frame corresponding to the reference frame (the frame including the same frame index as the reference frame) as the adjacent vertex list in the current frame.

The motion vector prediction unit 202E3 also applies the operation on the reference frame buffer to the specific buffer. Here, the operation on the reference frame buffer is, for example, a marking process disclosed in Non Patent Literature 4 or Non Patent Literature 5, chapter 9.2.4.4.

According to such a configuration, an effect of reducing a calculation amount for creating the adjacent vertex list including the decoded vertices picked up to the maximum usage number in the current frame can be expected.

However, in such a case, a specific buffer for storing the adjacent vertex list in one or a plurality of frames is required. Here, in order to minimize the size of the specific buffer, a further condition may be added to the above-described reuse condition.

For example, in addition to the above-described reuse condition, in a case where a condition that the reference frame is a frame immediately before the current frame in the decoding order is further satisfied, the motion vector prediction unit 202E3 can reuse the adjacent vertex list in the reference frame as the adjacent vertex list in the current frame.

In such a case, the motion vector prediction unit 202E3 may store only the adjacent vertex list in the frame immediately before the current frame in the decoding order in the specific buffer. Furthermore, the motion vector prediction unit 202E3 does not apply the operation on the reference frame buffer to the specific buffer. According to such a configuration, an effect of reducing the size of the specific buffer can be expected.

### Modification Example 2 of Inter Decoding Unit 202E

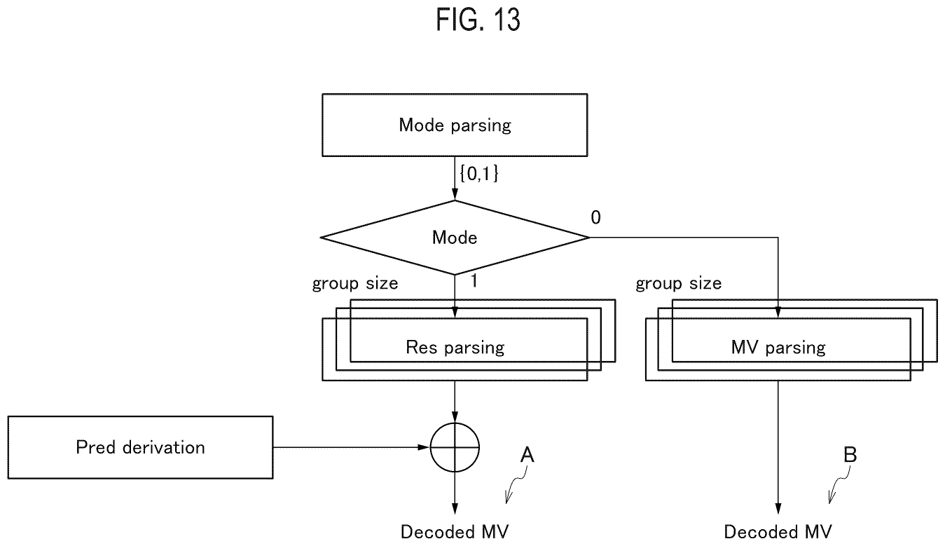

Hereinafter, Modification Example 2 of the inter decoding unit 202E will be described with reference to FIG. 13.

The motion vector calculation unit 202E4 of the inter decoding unit 202E has the mode 1 and the mode 0.

In the mode 1, the motion vector calculation unit 202E4 adds the MVR generated by the motion vector residual decoding unit 202E1 and the MVP output from the motion vector prediction unit 202E3, and outputs an MV of the vertex to be decoded (see A of FIG. 13).

On the other hand, in the mode 0, the motion vector calculation unit 202E4 outputs the MVR generated by the motion vector residual decoding unit 202E1 as an MV of the vertex to be decoded (see B of FIG. 13).

Note that the operation of the motion vector calculation unit 202E4 in the mode 0 corresponds to an operation of setting the MVP output from the motion vector prediction unit 202E3 to 0.

The motion vector calculation unit 202E4 may make the modes of MVs of N (N≥1) consecutive vertices the same in the decoding order.

The motion vector calculation unit 202E4 groups the above-described N vertices into one group. Such a size (group size) N of the group is 1 or more. The motion vector calculation unit 202E4 decodes a control signal (group size illustrated in FIG. 13) for calculating such a group size from the bit stream.

However, in a case where the number of vertices remaining in the last group is smaller than the group size, the motion vector calculation unit 202E4 puts all the remaining vertices into the group.

As described above, when the consecutive N vertices are set to the same mode, the code amount of the mode can be reduced, so that the effect of improving the encoding efficiency can be expected.

Here, as the number of consecutive vertices having the same mode increases, the effect of reducing the code amount of the mode increases. Therefore, it is necessary to set an appropriate group size in the mesh encoding device 100 and decode the group size from the bit stream as a control signal in the mesh decoding device 200.

Therefore, it is desirable that the settable range in such a control signal is not smaller than the number of consecutive vertices having the same mode in practice.

For example, in a case where almost the same mode is selected for all vertices, the group size may be set to the total number of vertices.

Table 4 illustrates examples of a case where the number of vertices for which the mode 0 is selected is 80% or more and a case where the number of vertices for which the mode 1 is selected is 90% or more.

Therefore, a settable range in the control signal is set to cover values from 1 to a preset maximum value. The maximum value is equal to or larger than the total number of vertices of the base mesh.

TABLE 4

| NAME OF | AVERAGE NUMBER | | |
|---|---|---|---|
| SEQUENCE | OF VERTICES | MODE 0 | MODE 1 |
| s8c2r1_levi | 649.96 | 2.20% | 97.80% |
| s8c2r2_levi | 2445.88 | 0.70% | 99.30% |
| s8c2r3_levi | 2445.88 | 0.70% | 99.30% |
| s8c2r4_levi | 4843.25 | 0.30% | 99.70% |
| s2c2r1_sold | 652.58 | 82.03% | 17.97% |

When the control signal (group size) is set to a natural number, in a case where the control signal (group size) is set to be equal to or larger than the total number of vertices, the absolute value is large, and thus the code amount is large.

Therefore, it is also possible to make the control signal logarithmic. Specifically, with the control signal as log 2_group_size, the group size may be calculated according to the following Expression (4).

$$group size = 2 log 2 \_group \_size \qquad Expression ( 4 )$$

Here, if there is only one group in the frame, the group is set as the last group. That is, when group size is larger than the number of vertices, all vertices are put into a group.

The range that can be set in the above-described control signal may be a clear value, or may be calculated from other control signals or data.

For example, the settable range in the control signal may be defined by Level 1.

Alternatively, the settable range in the control signal may be calculated from the number of vertices of the base mesh.

For example, the settable range in the control signal may be a minimum natural number that is a power of 2 that can cover the number of vertices of the base mesh.

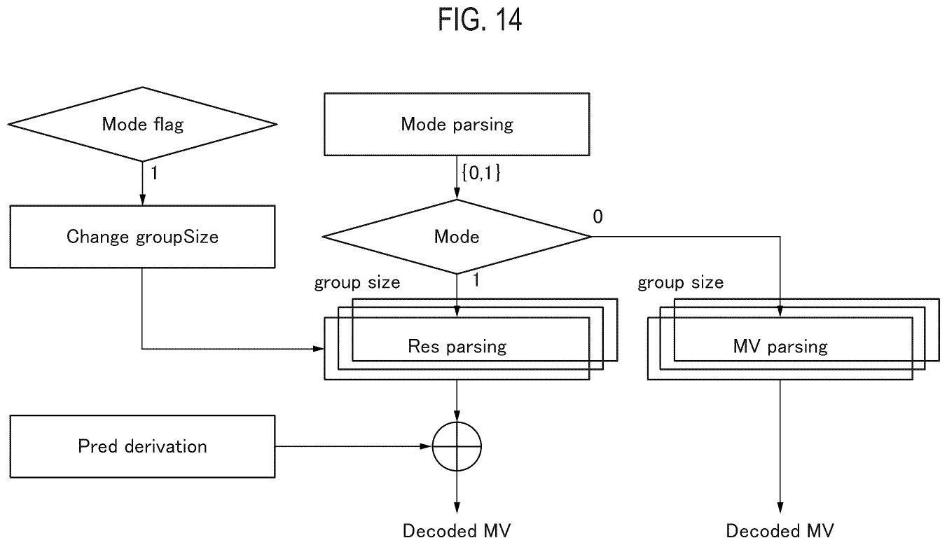

The settable range in the above-described control signal may be set to a small range, and then a predetermined flag (Mode flag) of another control signal may be introduced as illustrated in FIG. 14. In such a case, as illustrated in FIG. 14, when the predetermined flag is TRUE (Mode flag=1), the motion vector calculation unit 202E4 groups all the vertices into one (that is, the number of all vertices is set as the group size), and when the predetermined flag is FALSE, the motion vector calculation unit 202E4 keeps the group size calculated from the above-described control signal.

Note that the control signal may be set for each sequence or may be set for each frame. When the control signal is set for each sequence, the group sizes of all the frames are the same.

According to such a configuration, by determining the range in which the group size can be appropriately set, it is possible to cope with all situations, and an effect of reliably reducing the code amount of the mode and improving the encoding efficiency can be expected.

### Modification Example 3 of Inter Decoding Unit 202E

In the further modification example of the above-described inter decoding unit 202E, a configuration in which, before the above-described inter decoding unit 202E is implemented, the following functional blocks are added is made.

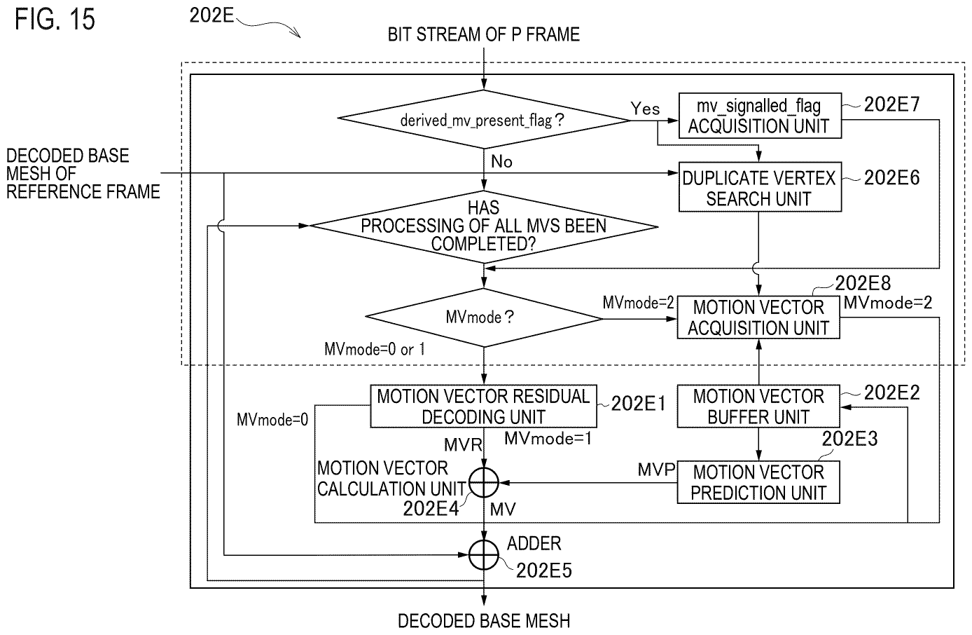

Specifically, as illustrated in FIG. 15, the inter decoding unit 202E includes a duplicate vertex search unit 202E6, an mv_signalled_flag acquisition unit (flag acquisition unit) 202E7, and a motion vector acquisition unit 202E8, in addition to the configuration illustrated in FIG. 8.

Here, derived_my_present_flag (first flag) is included at the beginning of the bit stream of the P frame and has at least a binary value of 0 or 1.

Furthermore, in a case where derived_my_present_flag indicates No, mv_signalled_flag (second flag) is included in the bit stream of the P frame and has a binary value of 0 or 1 for each vertex.

In a case where derived_my_present_flag indicates No (for example, in a case where derived_my_present_flag is 0), the mv_signalled_flag acquisition unit 202E7 decodes the motion vectors of all vertices from the bit stream of the P frame, and sets the value of mv_signalled_flag to 1 without decoding mv_signalled_flag of all vertices from the bit stream of the P frame.

In a case where derived_my_present_flag indicates Yes (for example, in a case where derived_my_present_flag is 1), the mv_signalled_flag acquisition unit 202E7 performs different processing at each vertex of the P frame. The mv_signalled_flag acquisition unit 202E7 may determine the processing method for each vertex using mv_signalled_flag.

Furthermore, in a case where derived_my_present_flag indicates Yes, and in a case where mv_signalled_flag of a certain vertex indicates Yes, the mv_signalled_flag acquisition unit 202E7 does not perform the processing in the motion vector acquisition unit 202E8 for the motion vector of the vertex, and performs processing similar to that of the inter decoding unit 202E illustrated in FIG. 7 or the modification example of the inter decoding unit 202E.

Furthermore, in a case where derived_my_present_flag indicates Yes and mv_signalled_flag of a certain vertex indicates No, the mv_signalled_flag acquisition unit 202E7 performs processing in the motion vector acquisition unit 202E8 for the motion vector of the vertex, and acquires the motion vector of the vertex.

For example, in a case where derived_my_present_flag indicates Yes, the mv_signalled_flag acquisition unit 202E7 decodes mv_signalled_flag for each vertex from the bit stream of the P frame.

In a case where derived_my_present_flag indicates Yes and in a case where mv_signalled_flag of a certain vertex indicates Yes, the mv_signalled_flag acquisition unit 202E7 sets the prediction mode (MV mode) of the vertex to 2.

On the other hand, in a case where derived_my_present_flag indicates Yes and in a case where mv_signalled_flag of a certain vertex indicates No, the mv_signalled_flag acquisition unit 202E7 sets the prediction mode of the vertex to a value other than 2.

Furthermore, in a case where derived_my_present_flag indicates No, the mv_signalled_flag acquisition unit 202E7 does not decode mv_signalled_flags of all vertices of the P frame from the bit stream, sets the value thereof to 1, and sets the MV mode of the vertex to a value other than 2.

The duplicate vertex search unit 202E6 is configured to search for indices of vertices (hereinafter, referred to as duplicate vertex) whose coordinates match each other from geometric information of the decoded base mesh of the reference frame and store the indices in a buffer (not illustrated).

Specifically, inputs of the duplicate vertex search unit 202E6 are the index (decoding order) and position coordinates of each vertex of the decoded base mesh of the reference frame.

In addition, the output of the duplicate vertex search unit 202E6 is a list that stores the index (vindex1) in a case where there is a duplicate vertex related to the index (vindex0) of each vertex, and stores the index (vindex0) of the vertex itself or a specific value (for example, −1) that is not used in the index of each vertex in a case where there is no duplicate vertex. Here, the list is stored in a buffer repVert in an order of index0.

In addition, since the vertex of vindex1 is decoded before vindex0, a relationship of vindex0>vindex1 is established.

The duplicate vertex search unit 202E6 determines, for each vertex (index: vindex0) of the basic mesh of the reference frame, whether or not there is a duplicate vertex related to the first vertex (index: 0) to the immediately preceding vertex (index: vindex0−1) of the basic mesh of the decoded reference frame, and outputs the index of the duplicate vertex by at least one of the following three types of methods in a case where the duplicate vertex search unit 202E6 determines that there is the duplicate vertex.

### Method 1

The duplicate vertex search unit 202E6 sequentially searches for duplicate vertices having matching coordinates as follows. When there is a duplicate vertex, vRref is vindex1, and when there is no duplicate vertex, vRef is −1.

```
  vRef =firstVertexIndexDuplicated(vindex0)
where
  firstVertexIndexDuplicated(v){
    for( i = 0; i<v; i++){
      if(referenceSubmeshVertexPositions[ i ]
==
  referenceSubmeshVertexPositions[ v ]) {
        return i
      }
    }
    return −1
  }
```

### Method 2

The duplicate vertex search unit 202E6 searches for duplicate vertices having matching coordinates using binary search. For example, the duplicate vertex search unit 202E6 may use the find function of the associative array class map.

### Method 3

The duplicate vertex search unit 202E6 searches for duplicate vertices having matching coordinates using the hash table. For example, the duplicate vertex search unit 202E6 may use the find function of the hash associative array class unordered_map.

Note that, as a method of finding the duplicate vertex in the basic mesh of the reference frame, a method of decoding the index of the duplicate vertex instead of the position coordinate from a special signal may be used for the vertex where the duplicate vertex exists.

In a case where MVmode is 2 (in a case where derived_my_present_flag indicates Yes, and mv_signalled_flag of the vertex indicates No), since there is a duplicate vertex of the vertex, the motion vector acquisition unit 202E8 is configured to acquire, from the motion vector buffer unit 202E2, the motion vector of the vertex having the index (vindex1) of the duplicate vertex related to the index (vindex0) of the vertex output from the duplicate vertex search unit 206E6, and set the motion vector of the vertex as the motion vector of the vertex.

That is, the index (vindex1) of the duplicate vertex is an output of the duplicate vertex search unit 206E, and is not decoded from the bit stream.

Here, in a case where MVmode is other than 2 (in a case where derived_my_present_flag indicates No, or in a case where derived_my_present_flag indicates Yes, and mv_signalled_flag of the vertex indicates Yes), processing similar to that of the inter decoding unit 202E illustrated in FIG. 7 or the modification example of the inter decoding unit 202E is performed, instead of the motion vector acquisition unit 202E8.

According to such a configuration, with respect to the vertex where the duplicate vertex exists, it is possible to expect an effect of reducing decoding calculation of motion vectors and of the code amount.

In the above-described further modification example of the inter decoding unit 202E, the duplicate vertex search unit 202E6 does not search for duplicate vertices from all vertices of the basic mesh of the reference frame, but searches for duplicate vertices only from among vertices whose mv_signalled_flag is No.

However, the input of the duplicate vertex search unit 202E6 includes mv_signalled_flag in addition to the index (decoding order) and position coordinates of each vertex of the basic mesh of the decoded reference frame.

According to the present modification example, since only the vertices having the duplicate vertices instead of all the vertices are searched for the duplicate vertices, it is possible to expect the effect of reducing the decoding calculation of the motion vector.

In the above-described further modification example of the inter decoding unit 202E, the mv_signalled_flag acquisition unit 202E7 decodes mv_signalled_flag in two stages.

The mv_signalled_flag acquisition unit 202E7 groups N vertices into one group, and then decodes, for each group, mv_group_signalled_flag (third flag) from the bit stream of the P frame, sets mv_signalled_flag of all vertices of the group in which mv_group_signalled_flag is 1 to 1, and decodes mv_group_signalled_flag from the bit stream of the P frame for each vertex of the group in which mv_group_signalled_flag is 0.

According to the present modification example, since mv_group_signalled_flag is decoded in two stages, it is possible to expect effects of reducing decoding calculation of the motion vector and a code amount.

In the above-described further modification example of the inter decoding unit 202E, the mv_signalled_flag acquisition unit 202E7 decodes mv_signalled_flag from the bit stream of the P frame not for each vertex but for a vertex having a duplicate vertex, and does not decode mv_signalled_flag from the bit stream of the P frame and sets mv_signalled_flag to 1 for a vertex having no duplicate vertex.

Note that the inter decoding unit 202E decodes, from the bit stream, a control signal indicating the number of vertices having duplicate vertices before mv_signalled_flag.

Such a control signal enables decoding of mv_signalled_flag without performing the processing of the duplicate vertex search unit 202E6.

In addition, as a requirement of conformance of the bit stream, the number of vertices having duplicate vertices output by the duplicate vertex search unit 202E6 is assumed to match the number of vertices indicated by the control signal.

In addition, the duplicate vertex search unit 202E6 stores all the duplicate vertex indices in another list. For example, the duplicate vertex search unit 202E6 may store all the duplicate vertex indices in duplicated_vertex_list as described below (modification example of Method 1).

### Modification Example of Method 1

The duplicate vertex search unit 202E6 sequentially searches for duplicate vertices having matching coordinates as described below. When there is a duplicate vertex, vRef is vindex1, and when there is no duplicate vertex, vRef is −1.

```
  vRef
=firstVertex IndexDuplicated(vindex0,duplicated_vertex_lis
t)
where
  firstVertexIndexDuplicated(v,duplicated_vertex_list)
{
    for( i = 0; i<v; i++){
      if(referenceSubmeshVertexPositions[ i ]
==
  referenceSubmeshVertexPositions[ v ]) {
  duplicated_vertex_list.push_back(v)
        return i
      }
    }
    return −1
  }
```

According to the present modification example, since mv_signalled_flag is provided not for all vertices but only for vertices having duplicate vertices, it is possible to expect effects of reducing decoding calculation of the motion vector and the code amount.

In the above-described further modification example of the inter decoding unit 202E, the mv_signalled_flag acquisition unit 202E7 may set mv_signalled_flag of a vertex having no duplicate vertex to 0.

Here, in a case where mv_signalled_flag of a vertex having no duplicate vertex is 0, since, in the basic mesh of the reference frame, there is no duplicate vertex but there is a vertex having the same motion vector, the mv_signalled_flag acquisition unit 202E7 decodes the index of the vertex having the same motion vector as the vertex from the bit stream of the inter-frame, and acquires the motion vector of the vertex.

Specifically, in a case where MVmode is 2 (in a case where derived_my_present_flag indicates Yes, and mv_signalled_flag of the vertex indicates No), when there is the duplicate vertex of the vertex, the motion vector acquisition unit 202E8 is configured to acquire, from the motion vector buffer unit 202E2, the motion vector of the vertex having the index (vindex1) of the duplicate vertex related to the index (vindex0) of the vertex output by the duplicate vertex search unit 202E6, and set the motion vector of the vertex as the motion vector of the vertex. However, in the present modification example, when there is no duplicate vertex of the vertex, the motion vector acquisition unit 202E8 is configured to decode the index (vindex1) of the vertex having the same motion vector as the vertex from the bit stream, acquire the motion vector of the vertex having the index (vindex1), and set the motion vector of the vertex as the motion vector of the vertex.

According to the present modification example, even in a vertex having no duplicate vertex, in a case where mv_signalled_flag indicates No, the motion vector is acquired from another vertex, and thus, it is possible to expect effects of reducing decoding calculation of the motion vector and the code amount.

Note that there are cases where the above-described modification examples can be simultaneously used or where it is not possible to simultaneously use the above-described modification examples. In a case where it is not possible to simultaneously use the above-described modification examples, a control signal indicating which modification example is used is provided, and the control signal is decoded from the bit stream to determine which modification example is used. However, the control signal may extend an existing control signal.

In the above-described further modification example of the inter decoding unit 202E, in a case where the reference frame is an inter frame, the duplicate vertex search unit 202E6 reuses the result acquired in the reference frame in the decoding target frame.

However, in a case where the reference frame is an intra frame, the duplicate vertex search unit 202E6 may reuse the information on the assumption that information regarding the duplicate vertex is provided.

Specifically, firstly, the duplicate vertex search unit 202E6 decodes, from the bit stream, a control signal indicating whether or not to reuse the result (information regarding the duplicate vertices, including the number of vertices having duplicate vertices) acquired in the reference frame in the decoding target frame. However, the duplicate vertex search unit 202E6 may use the existing control signal as it is or as an extension of the control signal.

Secondly, when the control signal is Yes, in a case where the reference frame is an inter frame, the duplicate vertex search unit 202E6 reuses the result obtained in the reference frame in the decoding target frame. However, in a case where the reference frame is an intra frame, the duplicate vertex search unit 202E6 may reuse the information on the assumption that the information regarding the duplicate vertex is provided.

Specifically, the output (the above-described result) of the duplicate vertex search unit 202E6 related to the reference frame is a list in which, in a case where there is a duplicate vertex related to the index (vindex0) of each vertex, the index (vindex1) of the duplicate vertex is stored, and, in a case where there is no duplicate vertex, the index (vindex0) of the vertex itself or a specific value (for example, −1) for which the index cannot be used is stored.

Here, such a list is stored in a buffer repVert in an order of vindex0.

In the following example, in a case where there is no duplicate vertex, the index (vindex0) of the vertex itself is stored. In addition, in order to clearly indicate the index tRef of the frame, a buffer repVert^{tRef} is displayed.

```
  repVert^{tRef}(vindex0)=vRef
  vRef=vindex1 if vindex0 and vindex1 are duplicate
vertices
  vRef=vindex0 if vindex0 and vindex1 are not
duplicate vertices
```

In a case where repVert^{tRef} is reused in the decoding target frame t, the duplicate vertex search unit 202E6 does not need to search for a duplicate vertex for each vertex (index: vindex0) of the base mesh of the reference frame of the decoding target frame, and only needs to use repVert^{tRef} as it is.

```
  repVert^{t}(vindex0)=vindex0 if
repVert^{tRef}(vindex0)=vindex0
  repVert^{t}(vindex0)=repVert^{tRef}(vindex0) if
repVert^{tRef}(vindex0)!=vindex0
```

According to the present modification example, since the duplicate vertex is not searched, the effect of reducing the decoding calculation of the motion vector can be expected.

In a further modification example of the above-described inter decoding unit 202E, when the reference frame is an inter frame, the mv_signalled_flag acquisition unit (flag acquisition unit) 202E7 reuses mv_signalled_flag acquired in the reference frame in the decoding target frame.

However, when the reference frame is an intra frame, the mv_signalled_flag acquisition unit 202E7 may reuse the mv_signalled_flag by assuming that the reference frame has the mv_signalled_flag.

Specifically, when derived_my_present_flag indicates Yes, the mv_signalled_flag acquisition unit 202E7 does not decode mv_signalled_flag for each vertex from the P-frame bit stream, and decodes a difference from the reference frame mv_signalled_flag.

Furthermore, the control signal may be provided when there is no difference in all mv_signalled_flags. In this case, the mv_signalled_flag acquisition unit 202E7 decodes the control signal, and if the control signal has a specific value (for example, TRUE), sets mv_signalled_flag of the reference frame as mv_signalled_flag of the target frame as it is, and if the control signal has a specific value (for example, FALSE), further decodes a difference from mv_signalled_flag of the reference frame to calculate mv_signalled_flag of the target frame.

According to the present modification example, the code amount reduction effect of mv_signalled_flag can be expected.

Note that there are cases where the above-described modification examples can be simultaneously used or where it is not possible to simultaneously use the above-described modification examples. In a case where it is not possible to simultaneously use the above-described modification examples, a control signal indicating which modification example is used is provided, and the control signal is decoded from the bit stream to determine which modification example is used.

### Modification Example 1 of Base Mesh Decoding Unit 202

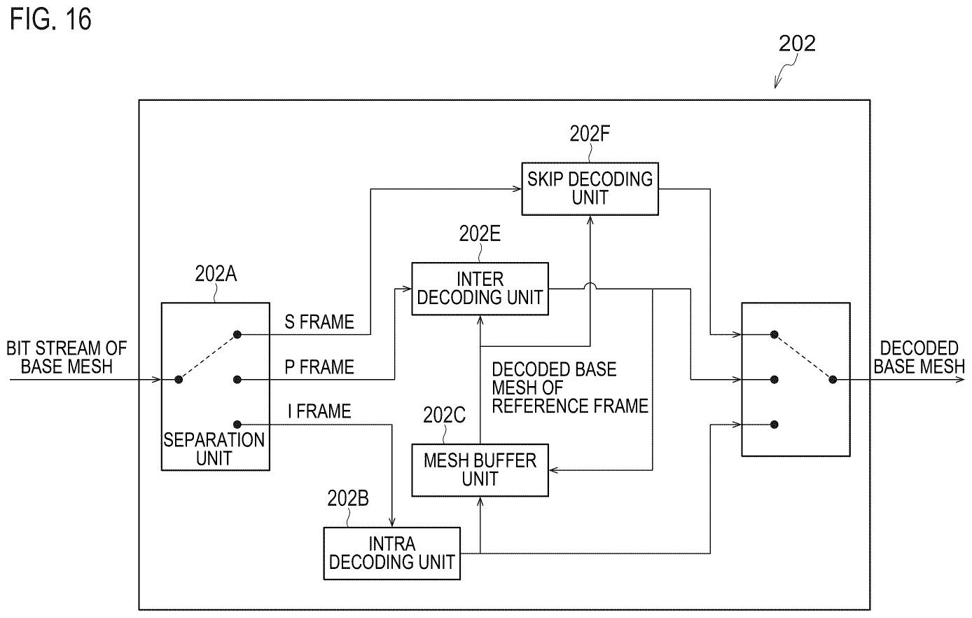

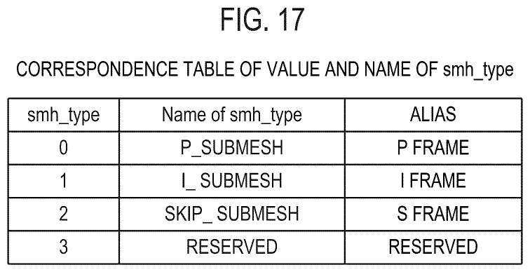

Hereinafter, Modification Example 1 of the base mesh decoding unit 202 will be described with reference to FIGS. 16 and 17.

As illustrated in FIG. 16, the base mesh decoding unit 202 according to Modification Example 1 includes a separation unit 202A, an intra decoding unit 202B, a mesh buffer unit 202C, an inter decoding unit 202E, and a skip decoding unit 202F.

The skip decoding unit 202F is configured to decode the base mesh of the frame to be decoded using the decoded base mesh of the designated reference frame as it is.

In the present embodiment, the frame may be a mesh or a submesh.

For example, as illustrated in FIG. 17, “P_SUBMESH” in smh_type may correspond to a P frame, “I_SUBMESH” in smh_type may correspond to an I frame, and “SKIP_SUBMESH” in smh_type may correspond to an S frame.

### (Skip Decoding Unit 202F)

The skip decoding unit 202F is configured to extract the decoded base mesh (reference decoded base mesh) of the reference frame designated from the mesh buffer unit 202C, and decode the coordinates of the vertex of the base mesh of the frame to be decoded and the index of the vertex using the coordinates of the vertex of the extracted reference decoded base mesh and the index of the vertex as they are.

Here, the mesh buffer unit 202C has at least one reference frame, and is configured to store at least one decoded base mesh for each reference frame.

The skip decoding unit 202F may specify a designated reference decoded base mesh using the control signal decoded from the bit stream or a predetermined rule.

For example, such a predetermined rule may be extracting the first reference frame of the reference frame list from the mesh buffer unit 202C or extracting the reference frame having the closest frame index to the frame to be decoded.

In the present embodiment, a frame for decoding the coordinates of the vertex of the base mesh using the coordinates of the vertex of the reference decoded base mesh and the index of the vertex as they are is referred to as an “S frame”.

According to such a configuration, since the motion vector can be made unnecessary in the skip decoding unit 202F, a significant reduction effect of the code amount and a significant reduction effect of the calculation amount can be expected.

### (Mesh Buffer Unit 202C)

The mesh buffer unit 202C is configured to store one or a plurality of reference decoded base meshes in a predetermined order.

Note that such a base mesh has metadata such as a frame number and a submesh number, at least coordinates of each vertex, and an index of the vertex, and is stored in the mesh buffer unit 202C in a predetermined order determined in the reference frame list.

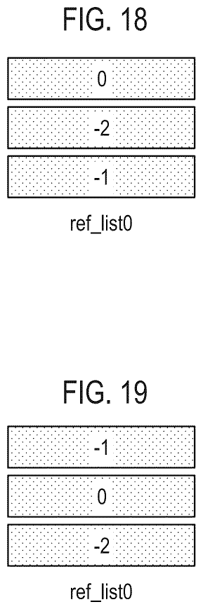

Here, as illustrated in FIG. 18, the reference frame list (ref_list0) is a list of information specifying all reference decoded base meshes stored in the mesh buffer unit 202C.

As illustrated in FIG. 18, the reference frame list may be determined by the control signal decoded from the bit stream, or may be naturally calculated from the decoding order of the frames.

Note that the control signal decoded from the bit stream may be indicated by a relative distance to the frame to be decoded or may be a frame index that is an absolute value.

Further, a short-term reference frame or a long-term reference frame may be used by the control signal.

For example, when a short-term reference frame is used, the absolute value (abs_delta_mfoc_st) of the difference between the display order (Display Order) of the frame (cur) and the reference frame (ref) and the sign (sign_flag) thereof may be decoded from the bit stream, and the display order (Display Order) of the reference frame may be designated by the following expression.

```
  If(sign_flag){
  Display Order(ref)=Display
Order(cur)+abs_delta_mfoc_st
  }else{
  Display Order(ref)=Display Order(cur)−
abs_delta_mfoc_st
  }
```

Furthermore, in a case where the method of naturally calculating the reference frame list from the decoding order of the frames is used, for example, when there is no control signal in the reference frame list, the frames may be sequentially arranged in a certain number of frames from the previously decoded frame. That is, the reference frame list may be {0, −1, −2, . . . , −(N−1)}.

Basically, the reference frame list does not change in each frame except for special circumstances (for example, when a re-ordering instruction is received).

The mesh buffer unit 202C may be updated as follows.

When the base mesh is decoded, in the case of the I frame and the P frame, the mesh buffer unit 202C deletes one or a plurality of existing reference frames in a predetermined order determined in the reference frame list, and adjusts the order of the reference frames by adding one or a plurality of base meshes including the base mesh of the decoded frame, or by creating and adding one base mesh from the plurality of base meshes.

Such deletion work may be performed only when the mesh buffer unit 202C expires. Note that the number of base meshes that can be stored in the mesh buffer unit 202C is determined in advance. Here, in the present embodiment, it is defined that the mesh buffer unit 202C expires when such number of base meshes is reached.

In the creation work described above, the coordinates of vertices corresponding to the base mesh of the decoded frame and the existing base mesh stored in the mesh buffer unit 202C may be weighted and averaged to form one base mesh.

The weight used in such weighted-averaging may be determined in advance, may be calculated using the frame index, or may be decoded from the control signal.

However, when the frame is the S frame, the mesh buffer unit 202C may perform such update or does not have to perform such update.

When receiving a control signal indicating an instruction for re-ordering on the basis of the control signal decoded from the bit stream, the mesh buffer unit 202C updates the reference frame list as illustrated in FIG. 19, and adjusts the order of the reference frames according to the predetermined order determined in the updated reference frame list (ref_list0).

### (Inter Decoding Unit 202E)

The inter decoding unit 202E is configured to decode the coordinates of the vertex of the P frame by adding the coordinates of the vertex of the reference frame extracted from the mesh buffer unit 202C and the motion vector decoded from the bit stream of the P frame.

The inter decoding unit 202E can adjust the index of the vertex of the P frame by the pair of indices A (k) and B (k) of the vertex existing as the overlapping vertex stored in the specific buffer. All or some of the indexes are decoded from the bit stream. Such a decoding method may be arithmetic encoding. According to such a configuration, an effect that the maximum value of the index to be decoded using the arithmetic encoding is not limited can be expected. For example, the arithmetic encoding of ue(v) may be used.

### Modification Example 2 of Base Mesh Decoding Unit 202

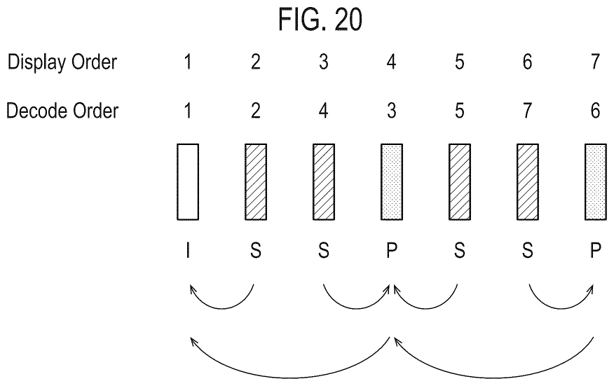

Hereinafter, Modification Example 2 of the base mesh decoding unit 202 will be described with reference to FIG. 20.

The skip decoding unit 202F will be described below, but may be applied to the inter decoding unit 202E.

As illustrated in FIG. 20, in the skip decoding unit 202F, the decoding order (Decode Order) and the display order (Display Order) are different in order to enable reference to the subsequent frame.

Here, the display order is the same as the order of input at the time of encoding, and is the same as the order of output at the time of decoding.

On the other hand, the decoding order is the same as the order of output at the time of encoding, and is the same as the order of input at the time of decoding.

Note that such a reference frame may be calculated by weighting and averaging the subsequent frame and one or a plurality of other frames.

However, in the case of referring to a plurality of frames including the subsequent frame, MR_SUBMESH (MR frame or B frame) is defined as the new frame type (smh_type) in FIG. 14, and MR_SUBMESH is decoded from the bit stream.

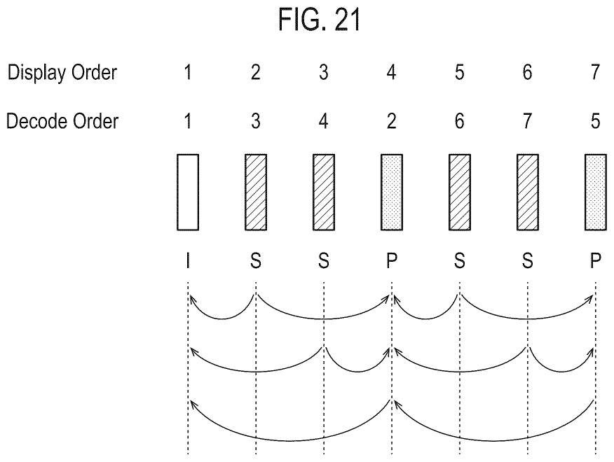

Furthermore, as illustrated in FIG. 21, such another frame may be a decoded frame immediately before the target frame.

Such a weight may be calculated using a frame interval between the target frame and the subsequent frame and a frame interval between the target frame and another frame, or may be determined in advance.

The base mesh decoding unit 202 decodes the control signal (smh_mesh_frm_order_cnt_lsb) from the bit stream, and decodes the output order.

Note that, when there are the submeshes defined in Non Patent Literature 4 (“WD 3.0 of V-DMC,” April 2023, ISO/IEC JTC 1/SC 29/WG 7 N00611) described above, all the submeshes are set to the same control signal (smh_mesh_frm_order_cnt_lsb), or the control signal (smh_mesh_frm_order_cnt_lsb) is applied to all the submeshes.

The value indicated by the control signal (smh_mesh_frm_order_cnt_lsb) may be a difference from the display order of the frame to be decoded, or may be an order in a frame group MaxMeshFrmOrderCntLsb determined in advance.

When the decoding order (Decode Order) and the display order (Display Order) are different and the decoded base meshes are arranged in the decoding order (Decode Order), the base mesh decoding unit 202 may rearrange the decoded base meshes in the display order (Display Order).

Note that, in the S frame in which the subsequent frame can be referred to, two mesh buffer units 202C may be provided, or when only one mesh buffer unit 202 is provided, at least one reference frame including a reference frame of which the display order is later than the frame to be decoded exists.

The skip decoding unit 202F designates the reference frame according to the control signal decoded from the bit stream or a predetermined rule, or by receiving re-ordering instruction.

Specifically, the skip decoding unit 202F designates a reference frame in the reference frame list according to such control signal.

Alternatively, the skip decoding unit 202F designates the first reference frame in the reference frame list.

Alternatively, the skip decoding unit 202F updates the reference frame list and the reference frame order of the mesh buffer unit 202C in response to the re-ordering instruction, and designates the first reference frame in such a reference frame list.

Note that, in the present embodiment, decoding of other frames is not affected even if the S frame is not decoded. Therefore, in a case where the S frame is not partially or entirely decoded, temporal scalability can be realized.

The base mesh decoding unit 202 may decode the base mesh of the S frame by integrating a plurality of reference frames according to the control signal.

For example, the base mesh decoding unit 202 may be configured to average the coordinates of the corresponding vertices in the base meshes of the two preceding and following reference frames, and decode the coordinates of the vertex of the base mesh of the frame to be decoded and the index of the vertex using the average coordinates and the index of the vertex as they are.

According to such a configuration, it is possible to obtain a high-quality base mesh while eliminating the need for motion vectors in the skip decoding unit 202F or the inter decoding unit 202E, so that an effect of improving the quality of the decoded mesh can be expected. Furthermore, an effect of realizing temporal scalability can be expected.

However, in order to realize temporal scalability, control signals Temporal_ID respectively indicating whether to decode the base mesh, the displacement, and the texture in each frame are defined, and decoded from the bit stream.

Further, Temporal_ID of the atlas and Temporal_ID of the base mesh may be matched in the same frame. Further, Temporal_ID of the atlas and Temporal_ID of the texture may be matched in the same frame. In addition, Temporal_ID of the atlas and Temporal_ID of the displacement may be matched in the same frame.

According to such a configuration, an effect that a frame that cannot be decoded and unnecessary data can be avoided can be expected.

It is desirable that an interval between adjacent frames having the same Tempora_ID be constant.

Adjacent frames having the same Temporal_ID are closest in POC.

By making the interval between the frames constant as described above, an effect of maintaining a constant frame rate when displaying the decoded frame can be expected.

Further, the decoding orders of the atlas and the base mesh having the same display order may be matched. In addition, the decoding orders of the atlas and displacement having the same display order may be matched. Further, the decoding orders of the atlas and the texture having the same display order may be matched.

Alternatively, the random access points of the atlas and the base mesh having the same display order may be matched. In addition, the random access points of the atlas and the displacement having the same display order may be matched. In addition, random access points of the atlas and the texture having the same display order may be matched. Note that the random access point is defined in Non Patent Literature 4 or Non Patent Literature 5.

According to such a configuration, an effect that the mesh can be reproduced without waiting for mutual decoding when the base mesh, the displacement, and the texture are decoded can be expected.

Further, a frame having Temporal_ID higher than the control signal Temporal_ID of the frame to be decoded is not used as such a reference frame of the frame to be decoded.

As a result, it is possible to expect an effect that there is no possibility that the reference frame is discarded.

Hereinafter, an example of realizing the temporal scalability using the above-described temporal_ID will be described.

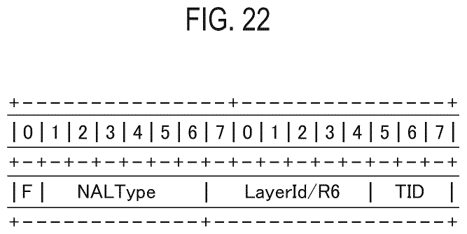

The bit streams of the atlas, the base mesh, the displacement, and the texture are encapsulated by a network abstraction layer (NAL) unit. The NAL unit may have a NAL header as illustrated in FIG. 22.

The TID defined as the last 3 bits in the NAL header is Temporal_ID plus 1. The range of the TID is from 1 to 7, and zero is prohibited.

LayerID/R6 defined as 6 bits immediately before TID in the NAL header designates an identifier of a layer to which the NAL unit belongs.

The value of LayerID/R6 should be in a range of 0 to 62. The value 63 may be designated by ISO/IEC in the future.

For purposes other than determining the amount of data for the decode unit of the bit stream, the mesh decoding device 200 ignores all pieces of data following the value 63 in the NAL unit, and the mesh decoding device 200 conforming to the designated profile ignores all NAL units in which the value of LayerID-R6 is not 0 (that is, being removed from the bit stream and discarded).

The value 63 of LayerID/R6 may be used to indicate an enhanced layer identifier in future extensions.

Note that when there are submeshes defined in Non Patent Literature 4, all the submeshes are set to the same TID, or the TID is applied to all the submeshes.

Non Patent Literature 5 can be used for the atlas, and HEVC or VVC of a video encoding system can be used for the displacement and the texture. Therefore, the base mesh will be described below.

The values of LayerID/R6 of all BMCL NAL units of the encoded base mesh frame should be the same. The value of LayerID/R6 of the encoded base mesh frame is the value of LayerID/R6 of the BMCL NAL unit of the encoded base mesh frame.

In a case where NALType is equal to NAL_EOB, the value of LayerID/R6 should be equal to 0.

In a case where NALType is in a range from NAL_BLA_W_LP defined in Non Patent Literature 4 to NAL_RSV_BMCL_29, that is, NALType belongs to an IRAP coded base mesh frame, Temporal_ID must be 0.

If NALType is equal to NAL TSA R or NAL TSA N, Temporal_ID should not be equal to 0.

When NALType is equal to 0 and NALType is equal to NAL_STSA_R or NAL_STSA_N, Temporal_ID should not be equal to 0.

The value of Temporal_ID should be the same for all BMCL NAL units in the access unit.

The value of Temporal_ID of the coded base mesh frame or the access unit is a value of Temporal_ID of the BMCL NAL unit of the coded base mesh frame or the access unit.

The value of Temporal_ID in the sublayer representation is the maximum value of Temporal_IDs of all BMCL NAL units in the sublayer representation.

A value of Temporal_ID of the non-BMCL NAL unit is limited as follows:
If NALType is equal to NAL_BMSPS, Temporal_ID should be 0, and Temporal_ID of the access unit including the NAL unit must be 0.
Otherwise, if NALType is equal to NAL_EOS or NAL_EOB, Temporal_ID must be 0.
Otherwise, if NALType is equal to NAL_AUD or NALLFDD, Temporal_ID must be equal to Temporal_ID of the access unit including the NALL unit.
Otherwise, Temporal_ID must be greater than or equal to Temporal_ID of the access unit including the NAL unit.

If the NAL unit is not the BMCL, the value of Temporal_ID is equal to the minimum value of Temporal_ID values of all the access units to which the non-BMCL NAL unit is applied.

If NALType is equal to NAL_BMFPS, Temporal_ID may be equal to or greater than Temporal_ID of the included access unit since all base mesh frame parameter sets (BMFPS) are included at the beginning of the bit stream of which Temporal_ID is 0 for the first encoded base mesh frame.

Note that the skip decoding unit 202F refers to the designated tIDTarget and discards the NAL unit of which Temporal_ID is higher than tIDTarget without decoding.

Here, tIDTarget may be designated by a value determined in advance, or may be designated by a network status or a terminal capability of the mesh decoding device 200.

For example, lower tIDTarget is designated in the radio case than in the wired case. Furthermore, in a case where the network status is poor, low tIDTarget is designated. Furthermore, in a case where decoding is performed by the low-spec mesh decoding device 200, low tIDTarget is designated.

However, a requirement of conformance of the bit stream is that at least one NAL unit of which Temporal_ID is not higher than tIDTarget needs to be present in the bit stream.

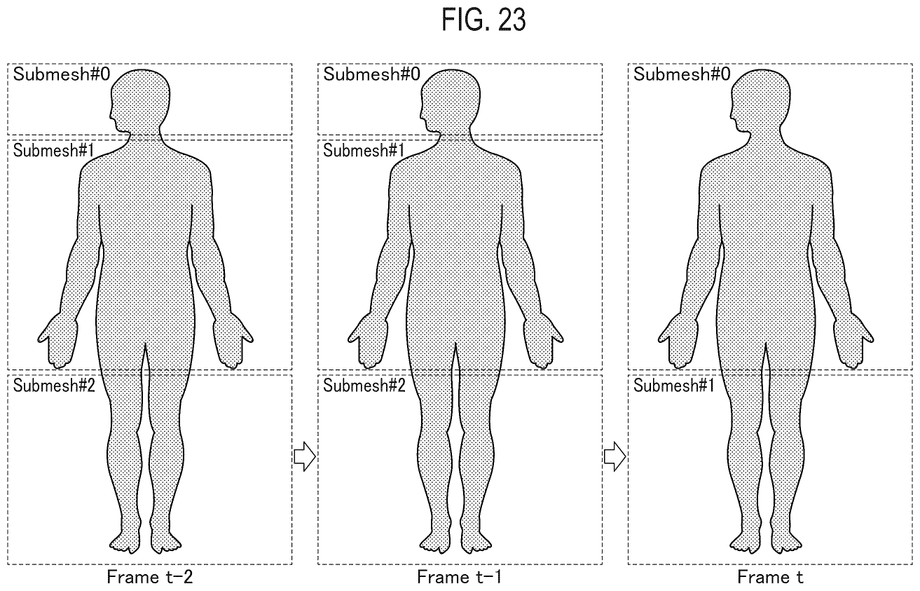

As illustrated in FIG. 23, the number of submeshes may be different in each frame (the intra frame, the inter frame, and the skip frame).

In such a case, the intra decoding unit 202B, the inter decoding unit 202E, and the skip decoding unit 202F assign non-overlapping submesh IDs to the respective submeshes in each frame.

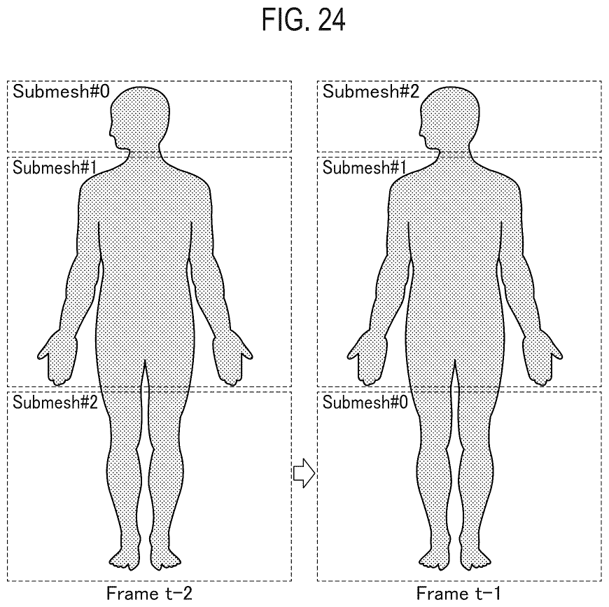

Furthermore, as illustrated in FIG. 24, the intra decoding unit 202B, the inter decoding unit 202E, and the skip decoding unit 202F may assign different SubmeshID (submesh IDs) to corresponding submeshes between frames.

However, it is assumed that the inter decoding unit 202E or the skip decoding unit 202F can refer to only submeshes having the same SubmeshID in the reference frame.

Alternatively, the inter decoding unit 202E or the skip decoding unit 202F can refer to only the submeshes having the same number of vertices in the reference frame.

Alternatively, it is assumed that the intra decoding unit 202B and the inter decoding unit 202E can refer to a submesh designated in the reference frame.

In such a case, in a case where there are a plurality of submeshes in the reference frame, the inter decoding unit 202E or the skip decoding unit 202F may decode a control signal designating SubmeshID of the referenceable submesh from the bit stream of the current submesh.

On the other hand, in a case where there is only one submesh in the reference frame, the inter decoding unit 202E or the skip decoding unit 202F may set such a submesh as a referenceable submesh.

However, in a case where the above-described control signal does not exist, the inter decoding unit 202E or the skip decoding unit 202F uses SubmeshID of the referenceable submesh as the same SubmeshID as that of the submesh in the current frame.

Furthermore, the inter decoding unit 202E or the skip decoding unit 202F may decode a control signal indicating whether or not the above-described control signal exists from the bit stream.

Note that the inter decoding unit 202E or the skip decoding unit 202F may decode a control signal for selecting the above-described method of determining a referenceable submesh.

The subdivision unit 203 and the displacement decoding unit 206 may follow Non Patent Literature 4.

According to the present invention, the calculation amount can be reduced by reusing the reference frame itself without searching for the decoded adjacent vertex.

Further, according to the present embodiment, in the inter prediction encoding, even in a case where the number of vertices of the base mesh of the current frame is different from the number of vertices of the reference frame or the reference submesh, the base mesh of the current frame can be decoded.

Furthermore, according to the present embodiment, it is possible to avoid a situation in which the number of vertices of the base mesh of the current frame is different from the number of vertices of the reference frame or the reference submesh in the inter prediction encoding.

Furthermore, according to the present embodiment, it is possible to specify which submesh is to be referred to by introducing a control signal indicating which submesh is to be referred to into the reference frame for the current frame in the inter prediction encoding.

Further, according to the present embodiment, in the inter prediction encoding, even if there is no information regarding which submesh is referred to in the reference frame for the current frame, which submesh is referred to can be specified.

Further, according to the present embodiment, it is possible to ensure that the base mesh has at least one face.

Further, according to the present embodiment, the Temporal_scalability function can be realized.

Furthermore, according to the present embodiment, the mesh encoding efficiency can be improved.

The mesh encoding device 100 and the mesh decoding device 200 described above may be implemented as programs that cause a computer to execute each function (each step).

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A mesh decoding device:
receives bit streams of atlas, a base mesh, a displacement, and a texture encapsulated by a network abstraction layer (NAL) unit, wherein
a TID defined as last 3 bits in a NAL header of the NAL unit is Temporal_ID plus 1, and
LayerID/R6 defined as 6 bits immediately before the TID in the NAL head designates an identifier of a layer to which the NAL unit belongs.

2. The mesh decoding device according to claim 1, wherein
Temporal_IDs of the atlas and the base mesh are matched in an identical frame.

3. The mesh decoding device according to claim 1, wherein
Temporal_IDs of the atlas and the texture are matched in an identical frame.

4. The mesh decoding device according to claim 1, wherein Temporal_IDs of the atlas and the displacement are matched in an identical frame.

5. The mesh decoding device according to claim 1, wherein
random access points of the atlas and the base mesh having an identical display order are matched.

6. The mesh decoding device according to claim 1, wherein
random access points of the atlas and the texture having an identical display order are matched.

7. The mesh decoding device according to claim 1, wherein
random access points of the atlas and the displacement having an identical display order are matched.

8. The mesh decoding device according to claim 1, wherein
the NAL unit of which the Temporal_ID is higher than tIDTarget is discarded without being decoded.

9. The mesh decoding device according to claim 8, wherein
a requirement of conformance of the bit stream is that at least one NAL unit of which the Temporal_ID is not higher than the tIDTarget needs to exist in the bit stream.

10. A mesh decoding method comprising:
a step of receiving bit streams of atlas, a base mesh, a displacement, and a texture encapsulated by a network abstraction layer (NAL) unit, wherein
a TID defined as last 3 bits in a NAL header of the NAL unit is Temporal_ID plus 1, and
LayerID/R6 defined as 6 bits immediately before the TID in the NAL head designates an identifier of a layer to which the NAL unit belongs.

11. A non-transitory computer-readable medium having stored thereon a program for causing a computer to function as a mesh decoding device, the mesh decoding device receiving bit streams of atlas, a base mesh, a displacement, and a texture encapsulated by a network abstraction layer (NAL) unit, wherein
a TID defined as last 3 bits in a NAL header of the NAL unit is Temporal_ID plus 1, and
LayerID/R6 defined as 6 bits immediately before the TID in the NAL head designates an identifier of a layer to which the NAL unit belongs.
